(19) United States
(12) Patent Application Publication
(10) Pub. No.: US 2008/0015785 A1
(43) Pub. Date: Jan. 17, 2008

(54) Mass Spectrometry Algorithm

(76) Inventors: Nedim Mujezinovic, Wien (AT); Karl Mechtler, Ladendorf (AT); Frank Eisenhaber, Wien (AT)

Correspondence Address: MICHAEL P. MORRIS;BOEHRINGER INGELHEIM CORPORATION, 900 RIDGEBURY RD, P O BOX 368, RIDGEFIELD, CT, 06877-0368, US

(21) Appl. No.: 11/457,570

(22) Filed: Jul. 14, 2006

(51) Int. Cl. G06F 19/00

(52) U.S. Cl. 702/19; 436/86

(57) ABSTRACT

The present invention provides algorithms for processing MS/MS spectra based on numerical spectral analysis and signal recognition, which (i) detect multiply charged replicates and transform them into singly charged mono-isotopic peaks, (ii) reduce isotope peak clusters to a single signal, (iii) remove high-frequency and periodic background noise, and (iv) determine non-interpretable spectra with low false-positive rate.

### BACKGROUND OF THE INVENTION

1. Field of the Invention

This invention relates to mathematical methods and algorithms for removal of multiply charged peaks, isotope replicates, and periodic and high-frequency noise from protein tandem mass spectrometry (MS/MS) spectra, as well as methods for the recognition of non-interpretable protein MS/MS spectra.

2. Description of the Prior Art

Developments in modern mass spectrometry (MS) made possible the large-scale analysis of cellular proteomes. Liquid chromatography coupled to tandem mass spectrometry (LC/MS/MS) is the standard equipment used for analysis of complex protein mixtures. Since modern mass spectrometers can generate large data sets with high throughput, computational analysis of thousands of spectra has become the major bottleneck. Both the accuracy of the computer-generated interpretations (the identity of the proteins and their posttranslational modifications) as well as the time for their computation are a matter of concern.

In many cases, but not always, beta-ions, gamma-ions, and their derivatives resulting from cleavage at peptide bonds are the most dominant signals in MS/MS spectra of peptides after their fragmentation by low-energy collision-induced dissociation (CID). However, MS/MS spectra contain typically many more peaks than can be expected from this fragmentation scheme. Some of them are repeated shifted signals due to the natural isotope distribution. The heavy isotope variants and the mono-isotope peak form isotope peak clusters that can be detected with high-resolution instruments. Electrospray ionization (ESI) allows measuring the masses of large molecules by producing multiply charged ions, thereby decreasing the mass-over-charge ratio into detectable ranges. If a fragment ion comprises several amino acid residues capable of acting as charge carrier, the same isotope peak cluster can be repeated with different charge states at different mass-over-charge values in the spectrum. Other interrupting signals originate from unknown fragmentation pathways, sample-specific or systematic chemical contaminations, and random noise produced by the electronic detection system. Removal of interrupting signals would lead to a decreased computational time needed for interpretation, as well as increased reliability of the interpretation result.

It is generally not possible to derive any benefit from the above-mentioned additional background peaks that may compose the majority of the spectrum. Their presence not only complicates computer-based spectrum interpretation by increasing the computation time, but, more critically, false interpretation of high-intensity signals as potential beta-related or gamma-related ions can lead, in some cases, to incorrect sequence interpretations of proteins or wrong identities of their post-translational modifications. Particularly, the de novo sequencing approach is affected by this problem where each peak is part of a sequence puzzle to be solved and, therefore, has initially to be considered as potential beta-ion or gamma-ion. In the case of algorithms based on protein sequence database searches, the danger of misinterpretation is not so dramatic, especially for protein targets without post-translational modifications, since the space of naturally occurring protein sequences is much smaller than the set of sequences that can be theoretically generated. Usually, a few dominating peaks of the major fragmentation row in the spectrum are sufficient to unambiguously determine the register of a peptide fragment in the original protein sequence. Nonetheless, when the nature of possible post-translational modifications is a priori unknown or when the database contains many proteins with similar peptides, the background can mis-direct database search methods, and result in incorrect protein identification.

Background processing of raw MS/MS spectra from protein samples has not been a focus of interest for a long time. Partly, this is associated with measurement accuracy since, for example, resolution of isotope clusters requires very precise instruments, which have only become available on a broad scale recently (for example, the Thermo Finnigan LCQ with close to ˜0.5 Da resolution and ˜0.3 Da accuracy of mass measurement or the newer LTQ with ˜0.3 Da resolution and ˜0.2 Da mass determination accuracy). Therefore, some spectrum interpretation algorithms foresee simplified exclusion rules for heavy ion peaks in their scoring or spectra pre-processing schemes. Similarly, de-convolution of multiply charged peaks and de-isotoping with procedures described in the literature are only possible with very accurate data and resolved isotope clusters. The results are reliable only in cases of large fragments where an isotope peak cluster of the higher charge state is confirmed by respective clusters at the lowest charge state or when the distances between peaks in a cluster accurately match the expected mass differences.

Sometimes, it might be advisable to refrain from automatically interpreting very noisy MS/MS spectra instead of generating interpretations that are not justified by the data. The task of unselecting non-interpretable spectra is related to, but different from, the question of cleaning spectra from noise. Xu et al. and Bern et al. propose empirical criteria for unselecting bad spectra; i.e., spectra with only few significant peaks over a dense background. For these methods, the relatively high number of false-positively unselected (i.e., nevertheless interpretable) spectra remains a problem.

Thus, while the number of mass spectra to be processed in proteomics laboratories is so large that there is no alternative to automated interpretation, the presence of additional background signals is largely ignored by currently available MS/MS spectrum analysis packages.

### SUMMARY OF THE INVENTION

The present invention provides fast algorithms for processing MS/MS spectra based on numerical spectral analysis and signal recognition. They (i) detect multiply charged replicates and transform them into singly charged mono-isotopic peaks, (ii) reduce isotope peak clusters to a single signal, (iii) remove high-frequency and periodic background noise and, finally, and (iv) can determine non-interpretable spectra with low false-positive rate. The approaches used are especially sensitive in detecting mild inaccuracies in the data. The algorithms may be implemented via a software package, such as a program written in the C/C++ language.

### BRIEF DESCRIPTION OF THE FIGURES

FIGS. 1A to 1H: Determination of multiply charged replicates with correlation analysis

FIG. 1A is a piece of raw spectrum.

FIG. 1B is a peak cluster from raw spectrum in large magnification.

FIG. 1C is the same peak cluster after removal of small peaks.

FIG. 1D is the same peak cluster after densification.

FIG. 1E is the pre-computed pattern of isotope peak cluster.

FIG. 1F is the same pattern after densification.

FIG. 1G is the peak cluster from raw spectrum with coefficients of correlation with the pre-computed pattern (in the lower part of the graph, multiplied with 100%).

FIG. 1H is the whole piece of raw spectrum with coefficients of correlation with the pre-computed pattern (in the lower part of the graph, multiplied with 100%).

FIGS. 2A to 2C: Deisotoping with removal of periodic background

FIG. 2A is the first power spectrum of a MS/MS dataset.

FIG. 2B is the second power spectrum of the first power spectrum of FIG. 2A.

FIG. 2C is the raw MS/MS spectrum (upper part of the diagram) and spectrum after removal of periodic background (lower part of the diagram), where arrows indicate cases of isotope variant identification.

FIGS. 3A and 3B: Detection of Phase-shifted MS/MS Spectra

FIG. 3A is an example of an easily interpretable MS/MS spectrum having a power spectrum derived with Fourier transformation that is typically quasi-periodic without phase shift.

FIG. 3b is an example of a difficult to interpret spectrum.

FIG. 4 is an algorithm for checking for sequence ladder tag in MS/MS spectrum.

FIGS. 5A to 5E: BSA—An Example of a Spectrum That Was Only Interpretable After Background Removal

FIG. 5A is a graph showing the original spectrum (all the peaks)

FIG. 5B is a graph showing the peaks that were removed (only the background peaks)

FIG. 5C is a graph showing the peaks that were maintained (the cleaned peaks)

FIG. 5D is the MASCOT interpretation

FIG. 5E is the table showing the assignments

FIG. 6 is an SDS-PAGE silver-stained gel of the purified human condensin complexes. The bands were previously identified by Yeong et al. (2003).

FIGS. 7A and 7B: The MS/MS spectrum from the condensin sample.

FIG. 7A is the full spectrum.

FIG. 7B is the higher mass-to-charge region in large magnification.

### DESCRIPTION OF THE INVENTION

The present invention provides methods for detection and transformation of multiply charged peaks into single charged mono-isotopic peaks, removal of heavy isotopes, random noise removal, and bad spectra recognition. The approach is based on numerical spectral analysis and signal detection methods. These methods may be implemented into a computer program useful for proteomics procedures. The methods rely on application of tools derived from numerical mathematics for the processing of MS/MS spectra with the goal to improve the signal-to-noise ratio.

### 1. Sample Preparation

200 μg of purified anti-human Smc2 rabbit polyclonal antibody, cross-linked to AFFI-GEL® Protein A beads (100 μl bed-volume, Bio-Rad Laboratories, Hercules, Calif.), was used to immunoprecipitate the condensin complexes from 10 mg of clarified interphase HeLa cell extract. Following extensive washing, immunoprecipitated protein complexes were acid-eluted from the beads, and 10% of the total eluate was analysed by SDS-PAGE and silver staining. After reduction and acetylation of cysteine residues using dithiothreitol and iodoacetamide, respectively, the condensin sample was proteolytically digested using Trypsin Gold (Promega, Madison, Wis.), and the digestion stopped with tetrafluoroacetic acid.

### 2. Mass Spectrometry

Tryptic peptides from condensin samples were separated by nano-HPLC on an UltiMate™ HPLC system and PepMap™ C18 column (Dionex-LC Packings, Sunnyvale, Calif.), with a gradient of 5-75% acetonitrile, in 0.1% formic acid. Eluting peptides were introduced by electrospray ionisation (ESI) into an LTQ linear ion trap mass spectrometer (Thermo Electron Corporation, Waltham, Mass.), where full-MS and MS/MS spectra were recorded. In another experiment, a mixture of tryptic peptides from standard, commercially acquired bovine serum albumin (bovine, BSA), alcoholdehydrogenase (yeast, ADH), or transferrin (human, TRF) were used for system optimization and testing. 100 fmol of each protein were injected into a NanoHPLC (Dionex-LC Packings, Sunnyvale, Calif.) and MS/MS spectra were acquired using a 3D ion trap mass spectrometer, model LCQ DECA XP (Thermo Electron Corporation, Waltham, Mass.).

### 3. File processing

The MS/MS output, in the form of an Xcalibur raw-file, was converted into dta-files using BioWorks software (Thermo Electron Corporation, Waltham, Mass. (53944 files in the case of the condensin sample)). The dta-files were merged to generate a single mgf-file (“MASCOT generic format”) using the merge.pl program (Matrix Science Ltd, London, UK). This original mgf-file was then processed using the IMP MS CLEANER program, using the default internal parameters, generating two mgf-files with cleaned and bad spectra respectively.

### 4. MS/MS data analysis

All three mgf-files (original and two processed) were used to perform MS/MS ion searches using MASCOT (Matrix Science Ltd, London, UK) on a local computing cluster, against the non-redundant database for the three test proteins, against a small curated protein database (146 sequences; 68753 residues), which includes components of the condensin, cohesin, and kinetochore complexes, as well as some common contaminants and trypsin, in the case of the codensin sample. The MASCOT search parameters were the same in all runs (enzyme: trypsin; fixed modifications: carbamidomethyl (Cys); variable modifications: oxidation (Met); peptide charges: 1+, 2+ and 3+; mass values: monoisotopic; protein mass: unrestricted; peptide mass tolerance: ±3 Da; fragment mass tolerance: ±0.8 Da; max. missed cleavages: 1). The MASCOT search results output html-file was formatted with standard scoring, a significance threshold of p<0.05, and an ion score cut-off for each peptide of 30.

### 5. Results and Discussion

As stated above, for raw protein tandem MS/MS spectra, the present invention provides four independent procedures (i.e., algorithms): (i) detection (or de-convoluting) of multiply charged peaks, (ii) the removal of latent periodic noise including de-isotoping, (iii) the removal of high-frequency random noise, and (iv) the detection of non-interpretable spectra.

### A. De-convolution of Multiply Charged Peaks

Although ionization techniques such as electrospray ionisation (ESI) have the advantage of shifting heavy ions into lower, detectable mass-over-charge ranges by generating multiply charged fragment ions, they can pollute the spectrum by causing replicates of otherwise identical ions at different charge states. In the general case, these multiply charged signals occur as isotope clusters. For the purpose of spectrum interpretation, peak replicates originating from different charge states have to be unified.

The relative spectral intensities of isotope-variant peaks in a cluster are determined by the natural isotope distributions of carbon, hydrogen, oxygen, nitrogen, and sulfur, the predominant chemical elements in peptide fragments. This a priori known form of the intensity pattern from multiply charged replicates is used for searching its re-occurrence in the measured spectrum by correlational analysis. The algorithm is quite robust relative to inaccuracies in the experimental resolution of isotope clusters due to two artifices in processing the mass spectrum: (i) the removal of small peaks very close to major intensities and (ii) the procedure of interpolated peak densification in the mass range of comparison with the predefined pattern.

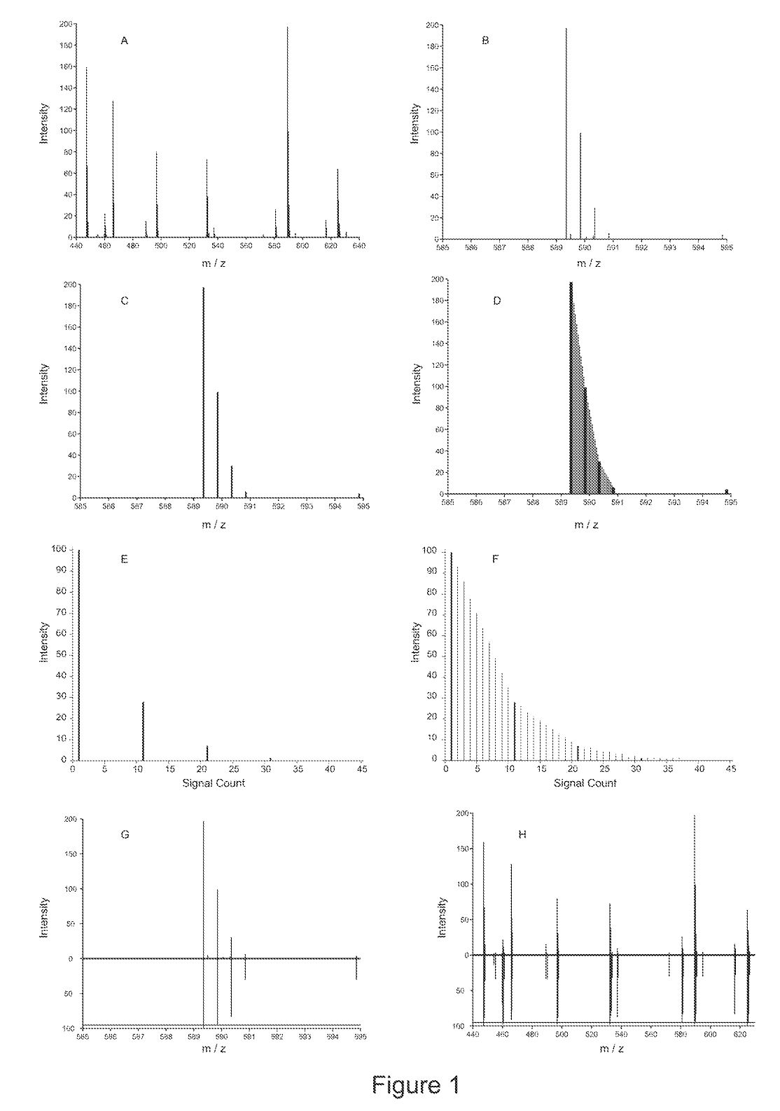

The algorithm includes several steps (see also FIG. 1). Prior to spectrum analysis, general forms of isotope cluster patterns are pre-computed for double- and triple-charged fragments. The intensity patterns in isotope clusters become complicated with large fragment masses but still can be exactly calculated. Given the large number of potential peptide fragment sizes and sequence possibilities, the computational time for taking into account the exact isotopic patterns is very high. Wehofsky's polynomial approximation is used for the target signal where the relative intensity of the n^{th} isotope variant peak (in a pattern of N≦7 peaks, k=6, the order of expansion) is:

$$I ( n , M ) = A ( n ) + {\sum }_{j = 1}^{k} {B}_{j} ( n ) {M}^{j} \qquad ( 1 )$$

M is the mass corresponding to the first, mono-isotopic peak in the cluster (n=1). The relative intensity of this peak is assumed 1. A(n) and Bⱼ(n) are fitting parameters taken from Wehofsky's work. Depending on charge state z, mass distance between peaks in the pattern is 1/z Da. The pattern length is (N−1)/z Da. Finally, the pattern is complemented, i.e., densified with 20(N−1)/ z−N+1 additional peaks (with a 0.05 Da mass step) where their intensity is linearly interpolated from the two surrounding pattern-defining peaks with masses M+(n−1)/ z and M+m/z. The intensity patterns have been tabulated with an accuracy of 100 Da.

Every peak of the experimental spectrum is considered a potential starting point of an isotope cluster pattern. The mass window with the length of the target signal following each peak is densified with linearly interpolated additional peaks (at 0.05 Da steps) up to the last experimental peak in the window. The addition of additional peaks (essentially a transformation to a semi-analogue signal) compensates for possible small inaccuracies in resolving the position of isotope-variant peaks by the instrument's software. The correlation coefficient of the observed intensities with those from the pre-computed pattern is calculated. Very high correlation (above 0.95 or even 0.99 (in the case of very accurate data)) indicates re-occurrence of the target signal in the pattern. Detected multiply charged peak clusters are removed and converted into a singly charged mono-isotopic peak that is added to the spectrum.

This procedure works adequately as long as no very low-intensity peaks close to major intensities of an isotope cluster interfere (distance below ˜0.2 Da, a measure of machine accuracy). These peaks are typically artifacts that can arise from random noise or from the transformation of the continuous MS/MS spectrum into the centroid form as a discrete signal. Prior to the spectrum densification, the small interfering peaks between main isotope cluster peaks have to be merged with the closest main peak in the cluster; i.e., this is essentially a procedure for reversing the creation of the small interfering peaks. For the peak-merging algorithm, a weighted directed graph G(V,E)is constructed. The set of vertices (V) is all mass-over-charge values in the window. An edge e_{i,j}εE is added between two vertices vᵢ,vⱼεV if the distance d between peaks vᵢ, vⱼ is less than a user-defined value (˜0.2 Da). The direction of the edge is defined to be from vᵢ, to vⱼ if Intensity(vᵢ)<Intensity(vⱼ). The weight wᵢ of an edge e_{i,j} is defined as distance between two vertices vᵢ and vⱼ (in 0.01 Da units). If a node vᵢ giving origin to the edge e_{i,j} is actively removed from the graph (and its intensity is added to the node vⱼ), then edges to other nodes can also vanish. Via systematic enumeration (for example with topological ordering), an edge-free sub-graph can be computed without large computational cost that fulfills the condition that the sum of weights of actively removed edges is minimal.

In light of the foregoing, referring to FIGS. 1A to 1G, there is show a series of diagrams to illustrate the process of removing multiply charged replicates. The abscissa represents the mass-over-charge ratio (the signal count in 0.1 Da/charge units in FIGS. 1E and F); the ordinate axis shows peak intensity in relative units. To the order of diagrams: A and B are in the first row, C and D in the second, etc. FIG. 1A is a piece of raw MS/MS spectrum. FIG. 1B is the peak cluster from the raw spectrum at greater magnification. FIG. 1C is the same peak cluster after removal of small peaks. FIG. 1D is the same peak cluster after densification. FIG. 1E is the pre-computed pattern of the isotope peak cluster and FIG. 1F is the same pre-computed pattern after densification. In FIGS. 1E and 1F, only the relative abscissa value is important (with an undefined additive constant). FIG. 1G is the peak cluster from the raw spectrum together with coefficients of correlation with the pre-computed pattern (in the lower part of the graph, multiplied by 100%; the horizontal line corresponding to 95% is shown). Finally, FIG. 1H is the whole raw spectrum together with coefficients of correlation with the pre-computed pattern (in the lower part of the graph, multiplied by 100%; the horizontal line corresponding to 95% is shown).

### B. Removal of Latent Periodic Noise Including De-Isotoping of the Spectrum.

Correlation of the measured MS/MS spectrum with pre-calculated isotopic intensity distributions is efficient only for multiply charged peak clusters since the probability of finding additional, unrelated peaks in the spectrum with distance of 1 Da is high. Therefore, correlation analysis with pre-defined patterns is not really useful for de-isotoping. But if an MS/MS spectrum is treated as a set of signals in time domain where the mass-over-charge axis is the analogue of time and intensity of each peak in MS/MS spectrum as the intensity of a signal at certain time, the single-charged peak signals can be considered as a periodical function (with periodicity of ˜1 Da for singly charged peaks). This periodical function in time domain results in a periodical function in the power spectrum where the reoccurring elements can be recognized more easily.

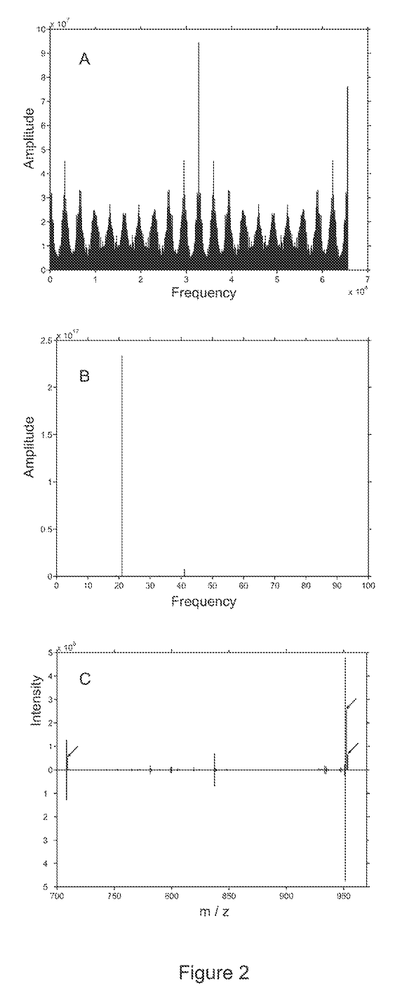

Besides isotope variants, there can be other sources of spectral contamination with latent periodicity, for example, from the detection system or from accompanying chemical polymer contaminants such as silanes, etc. Re-occurring signals at quasi-constant mass shifts can be seen in the frequency domain, i.e., as characteristic reoccurrences of high amplitudes at multiples of a base frequency in the Fourier transform of the tandem mass spectrum. Performance of yet another Fourier transformation applied at the frequency domain level can be used to determine this base frequency. Suppression of intensities in protein tandem mass spectra arising from these periodicities effectively removes latent periodical noise including minor isotope variant peaks (FIG. 2).

Converting to the frequency domain, the discrete Fourier transform Y of the MS/MS spectrum (S) is found by taking the N-point fast Fourier transform Y=FFT(S,N). The value N is calculated as N=2ⁿ⁺¹, where n is the smallest integer larger than log₂[(xₘₐₓ−xₘᵢₙ)/0.05]. The values xₘₐₓ and xₘᵢₙ are the largest and the smallest mass-over-charge values in the spectrum respectively. The first power spectrum PS, a measurement of the power at various frequencies, is PS=Y·Y*/N (see FIG. 2A). Typically, the power spectrum of a good MS/MS spectrum is quasi-periodic. The length of this period (the base frequency) is determined with another Fourier-transformation, where the power spectrum is considered as a signal in the time domain (see FIG. 2B).

In order to remove the reoccurring elements from the first power spectrum, a multi-band reject filter has to be created for each MS/MS spectrum. The filter is created by the Yulewalk method of autoregressive moving average (ARMA) spectral estimation. Yulewalk designs recursive infinite impulse response (IIR) digital filters using a least squares fit to a specified frequency response. Frequencies required by the Yulewalk method are calculated by applying a median filter to the power spectrum (over 300-500 discrete data points) and by computing a second power spectrum (PSPS) in order to get the most prominent frequency of the first power spectrum. The created IIR filter is used to filter the MS/MS spectrum in time domain. After filtering, the recovered MS/MS spectrum might contain some signals with negative intensity or some new signals with positive intensity. Also, some signals from the original raw spectrum loose considerable intensity (threshold of 95%; this number should be higher for very clean and regular spectra). All three types of signals are corrected to zero in a final step.

Examination of exemplary spectra has shown that suppression of latent periodicities in the MS/MS spectrum effectively also removes low-intensity peaks originating from higher mass isotopes in isotope clusters (see FIG. 2C).

In light of the foregoing, referring to FIGS. 2A to 2C, a series of diagrams illustrates the procedure of removing latent periodical background. FIG. 2A is a first power spectrum of an MS/MS spectrum. The amplitude in relative units is shown at the ordinate. At the abscissa, the frequency ranges from zero up to and including the double Nyquist frequency. Therefore, the graph is symmetric relative to a line perpendicular to the abscissa of about 33000. FIG. 2B is the power spectrum of the power spectrum of FIG. 2A. The major peak is at abscissa 21, the number of quasi-repeats in A. It should be noted that, typically for interpretable MS/MS spectra, the second power spectrum is also quasi-periodical (peaks at 21, 42, etc.). FIG. 2C is the raw MS/MS spectrum (upper part of the diagram) and spectrum after removal of periodic background (lower part of the diagram). Arrows indicate cases of isotope variant identification. The axes show the mass-over-charge ratio and the relative intensity respectively.

### C. Removal of High-Frequency Random Noise.

Assuming that the random noise in MS/MS spectrum exists as signals of high frequency of occurrence, a low-pass filter (i.e., Butterworth IIR) is applied to the spectrum in time domain. Normalized stop frequency of the filter is in the range from 0.5 to 0.9 (the best result was obtained with stop frequency 0.8). An empirical threshold of 99.99% is applied to remove all signals, which have lost intensity above this threshold, from the raw spectrum.

### D. Recognition of Non-Interpretable Spectra.

### I. Detection of Phase-Shifted MS/MS Spectra

Power spectrum analysis of MS/MS spectra also indicates a criterion that can be used for the identification of bad spectra which are not useful for further study. Two types of irregularities are observed that coincide with hard-to-interpret protein MS/MS spectra: (i) the first power spectrum can exhibit very low amplitudes for low frequencies, and (ii) finding the most prominent frequency in the second power spectrum can be ambiguous (several similarly high peaks).

With the base frequency derived from the second power spectrum (PSPS), it is possible to compute the position of expected maxima and minima in the first power spectrum (PS) and determine whether the real minima and maxima within periods are, on average, closer to the expected positions or closer to the positions with the shift of half a period. If the spectrum is shifted (i.e., if the sum of distances of real maxima and minima from their expected positions is larger than that of the positions with a shift of half a period) away from the expected position of minima/maxima, the procedure for de-isotoping is halted because large spectral shifts away from expected minima/maxima often indicate bad spectra.

For making an appropriate decision, the periodicity of the spectrum is also tested with a similarly elementary criterion as the shift. This is tested with the coefficient of dispersion (C_{d}) of peak distances in the first power spectrum, calculated as a ratio of standard deviation (s) and the mean value ( X̅).

$${C}_{d} = \frac{s}{ \overline{X}} \qquad ( 2 )$$

A C_{d} close to zero indicates good coincidence of distances between maxima (and, respectively, minima) of consecutive periods with the expected distance (equal to the period length). Large values of C_{d} signal distorted periodicity in the power spectrum and a periodicity model appears not applicable. Such spectra are returned to further processing without removal of latent periodic noise.

The case of quasi-periodic but shifted spectra is more complicated. In such a situation, if the coefficient of dispersion is not larger than 3.3 (an empirically derived threshold), the algorithm predicts that the respective MS/MS spectra cannot be reliably analyzed with interpretation software. As will be shown below, spectra flagged with this criterion are indeed not well interpretable even with database search-based software (i.e., no protein hits are found or only hits with very low reliability).

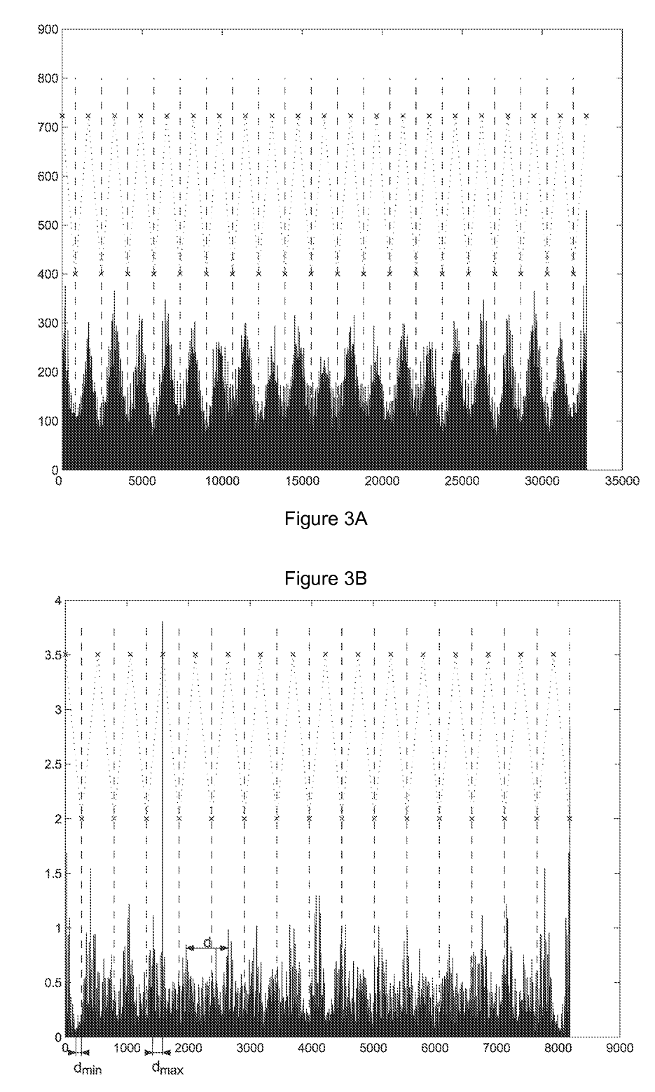

Referring to FIG. 3A, there is shown as an example of an easily interpretable MS/MS spectrum having a power spectrum derived with Fourier transformation that is typically quasi-periodic without phase shift. Also shown is the power spectrum from zero to the doubled Nyquist frequency. Having the number of periods determined from the second power spectrum, the expected positions of minima and maxima in the first power spectrum can be calculated. With dashed lines, the abscissa positions of expected minima of intensity are indicated. Both expected minima and maxima positions are emphasized at the respective abscissa values with markers (crosses), which are interconnected via a dotted line for visual guidance. Obviously, the true minima and maxima of the power spectrum coincide well with their expected positions.

In contrast, referring to FIG. 3B, there is shown an example of a difficult to interpret spectrum. The true maxima and minima of the respective periods are irregularly shifted with respect to the expected positions. The expression dₘᵢₙ denotes the distance between the true and the expected position of a minimum within a period, dₘₐₓ measures the deviation for the maximum (a thin continuous line denotes the expected position of the respective maximum). The peak distance d is the difference of abscissa positions between maxima of consecutive periods (similarly for the minima). The standard deviation s and the mean value X are calculated from the set of all peak distances.

### II. Detection of the Presence of Putative Amino Acid Sequence Ladders

Sequence ladder testing is a simple and efficient alternative with virtually no false positives. At the same time, the rate of spectra recognized as non-interpretable in form of peptide sequences increases up to the order of ˜70%.

Peptide samples that are to be analysed by tandem mass spectrometry often contain other compounds that are not of protein origin. These compounds are different polymers and other impurities as artefacts of the preparation methods. Although these compounds occur in small concentrations, the high sensitivity of modern mass spectrometers allows their detection. The presence of these unusable non-peptide spectra in a large number in the resulting set of all mass spectra inordinately consume CPU time trying to interpret them as peptide fragments.

The MS/MS spectra that originate from peptides can be distinguished from non-peptide spectra by the presence of a ladder of peaks with characteristic distances between them, namely the amino acid residue mass. If a spectrum doesn't contain a reliable number of peaks that form an amino acid sequence ladder, this spectrum can be considered as bad, and can be removed from the set of spectra that is to be used for interpretation.

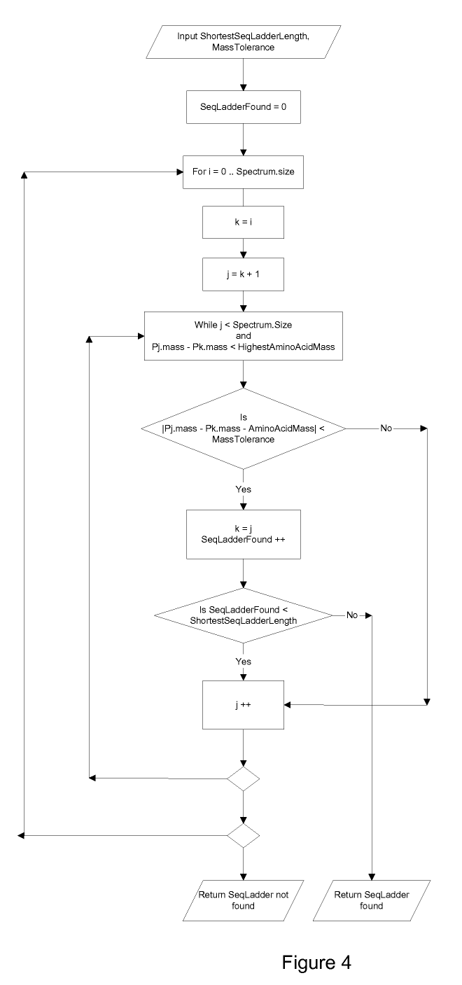

Therefore, referring to FIG. 4, the present invention contemplates an algorithm to test whether an MS/MS spectrum originates from non-peptides and, therefore, can be removed without losing usable information about the protein sample. Input information for the algorithm is the shortest length of the amino acid sequence ladder, and the mass tolerance used for the sequence ladder search. The application of this seemingly simple criterion makes a dramatic difference for the amount of mass spectra to be analyzed. Even for a requested sequence ladder (sequence tag length=3, mass tolerance 0.1 Dalton; Table 1), the IMP MS CLEANER program recognizes ca. 60% (ADH: 61%, TRF: 60%, BSA: 57%) of all spectra as non-interpretable in terms of peptide sequences. Only in a single case, a spectrum was false-positively removed as non-interpretable, apparently since the truly existing sequence ladder had not been recognized within the required low mass tolerance. This problem disappears with enlarged mass tolerance (0.3 Dalton, see Table 2) even if the requested length of the sequence ladder is enlarged to 4 or 5 amino acid residues. At the same time, the number of unselected non-interpretable spectra is well above 60% for length 4 and between 70% and 80% for length 5.

TABLE 1
Application sequence-ladder-testing with mass tolerance 0.1
and sequence tag length 3

| | | Before | | |
|---|---|---|---|---|
| Protein | | cleaning | After cleaning | Bad spectra |
| ADH | No. of Spectra: | 2325 | 907 | 1418 |
| Parameters: | Scores: | 468 | 534 | 0 |
| Sequence Tag length: 3 | Queries matches: | 20 | 23 | 0 |
| Mass Tolerance: 0.1 | Seq. coverage: | 26% | 29% | 0 |
| Rigorous detection of bad spectra | | | | |
| Cleaning time: 07:40.55 | | | | |
| TRF | No. of Spectra: | 2608 | 1032 | 1576 |
| Parameters: | Scores: | 1383 | 1479 | 56 |
| Sequence Tag length: 3 | Queries matches: | 49 | 50 | 1 |
| Mass Tolerance: 0.1 | Seq. coverage: | 38% | 39% | 3% |
| Rigorous detection of bad spectra | | | | |
| Cleaning time: 06:53.07 | | | | |
| BSA | No. of Spectra: | 2679 | 1142 | 1537 |
| Parameters: | Scores: | 1229 | 1579 | 0 |
| Sequence Tag length: 3 | Queries matches: | 47 | 59 | 0 |
| Mass Tolerance: 0.1 | Seq. coverage: | 43% | 52% | 0 |
| Rigorous detection of bad spectra | | | | |
| Cleaning time: 06:08.70 | | | | |

Scores in this table are the MASCOT scores. Matching queries are those spectra that have been interpreted as peptides by MASCOT.

TABLE 2
Application sequence-ladder-testing with mass tolerance 0.3 Dalton and enlarged
sequence tag length

| | | Before cleaning | After | |
|---|---|---|---|---|
| Protein | | (default settings) | cleaning | Bad spectra |
| ADH | No. of Spectra: | 2325 | 548 | 1741 |
| Parameters: | Scores: | 468 | 468 | 0 |
| Sequence Tag length: 5 | Queries matches: | 20 | 22 | 0 |
| Mass Tolerance: 0.3 | Seq. coverage: | 26% | 30% | 0% |
| Rigorous detection of bad spectra | | | | |
| Cleaning time: 08:21.71 | | | | |
| TRF | No. of Spectra: | 2608 | 862 | 1746 |
| Parameters: | Scores: | 1383 | 1479 | 0 |
| Sequence Tag length: 4 | Queries matches: | 49 | 59 | 0 |
| Mass Tolerance: 0.3 | Seq. coverage: | 38% | 39% | 0% |
| Rigorous detection of bad spectra | | | | |
| Cleaning time: 07:03.50 | | | | |
| BSA | No. of Spectra: | 2679 | 590 | 2089 |
| Parameters: | Scores: | 1229 | 1579 | 0 |
| Sequence Tag length: 5 | Queries matches: | 47 | 59 | 0 |
| Mass Tolerance: 0.3 | Seq. coverage: | 43% | 52% | 0% |
| Rigorous detection of bad spectra | | | | |
| Cleaning time: 08:39.66 | | | | |

See legend of Table 1.

TABLE 3
Application sequence-ladder-testing with mass tolerance 0.3 Dalton, enlarged
sequence tag length, and softened spectral criterion for detection of non-interpretable
spectra

| | | Before cleaning | | |
|---|---|---|---|---|
| | | (default | | |
| Protein | | settings) | After cleaning | Bad spectra |
| ADH | No. of Spectra: | 2325 | 893 | 1432 |
| Parameters: | Scores: | 468 | 534 | 0 |
| Sequence Tag length: 4 | Queries matches: | 20 | 23 | 0 |
| Mass Tolerance: 0.3 | Seq. coverage: | 26% | 29% | 0% |
| Rigorous detection of bad spectra | | | | |
| Cleaning time: 08:45.22 | | | | |
| TRF | No. of Spectra: | 2608 | 406 | 2202 |
| Parameters: | Scores: | 1383 | 1490 | 0 |
| Sequence Tag length: 5 | Queries matches: | 49 | 51 | 0 |
| Mass Tolerance: 0.3 | Seq. coverage: | 38% | 39% | 0% |
| Soft detection of bad spectra | | | | |
| Cleaning time: 07:10.41 | | | | |
| BSA | No. of Spectra: | 2679 | 616 | 2063 |
| Parameters: | Scores: | 1229 | 1593 | 0 |
| Sequence Tag length: 5 | Queries matches: | 47 | 59 | 0 |
| Mass Tolerance: 0.3 | Seq. coverage: | 43% | 52% | 0% |
| Soft detection of bad spectra | | | | |
| Cleaning time: 08:39.66 | | | | |

See legend of Table 1.

### 6. Results of Background Removal in MS/MS Spectra Obtained with 100 Fmol BSA, ADH, and TRF.

To test the algorithms of the present invention in large-scale practical applications, MS/MS spectra from protein samples with known composition were used. Such spectra are produced for the purpose of quality control of MS instrumentation with low concentrations (100 fmol) of BSA, ADH, or TRF. It should be noted that low concentrations of proteins are used in order to achieve limiting cases of mass spectra intentionally. The results of applying the background removal procedure are presented in Tables 4A and 4B hereinbelow. First, it is evident that protein hits are found from the cleaned MS/MS spectra with considerably increased scores. This is evident for the total protein score (between 10% and 15%, see Table 4A). Scores improve for the majority of all leading peptide hits (about 70%, see Table 4B), a decrease is observed in about 10% of cases but did not affect the interpretation except for one case (see below). In general, the likelihood of retrieving the sample protein and the sequence coverage improve (see Table 4A).

MS/MS spectra considered non-interpretable by use of the current invention are indeed bad spectra. In only one out of 626 cases was the original protein recovered by MASCOT. Here, MASCOT assigned a score of 64 (see Table 4A). This height appears unjustified upon visual inspection of the spectrum, because there are almost no significant peaks above background. In contrast, there are a considerable number of spectra (about 10%) that become interpretable for MASCOT only after background removal with our procedures (5 for BSA, 1 for ADH, 8 for TRF, see Table 4B).

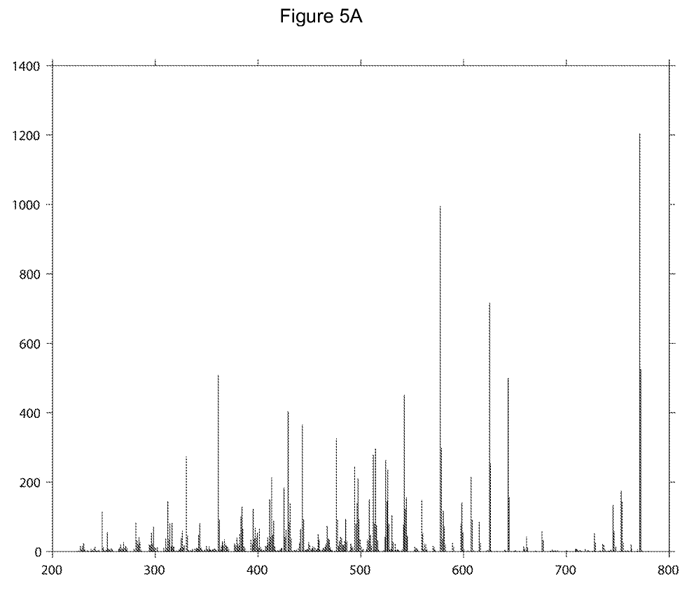

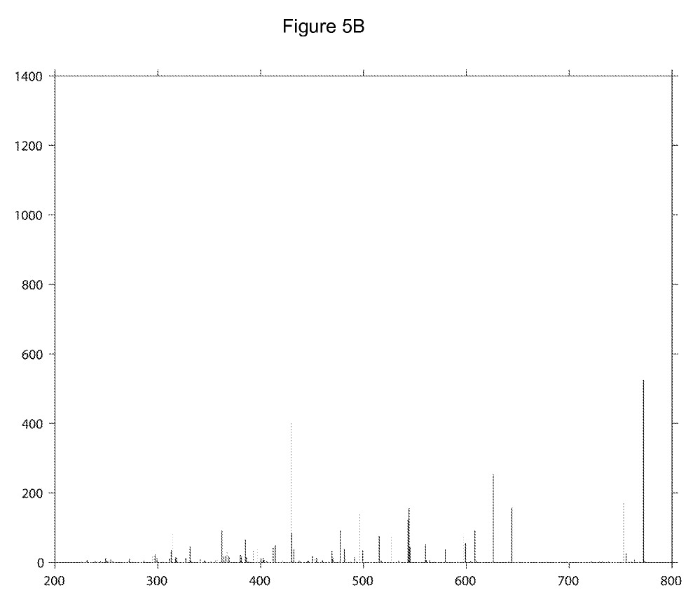

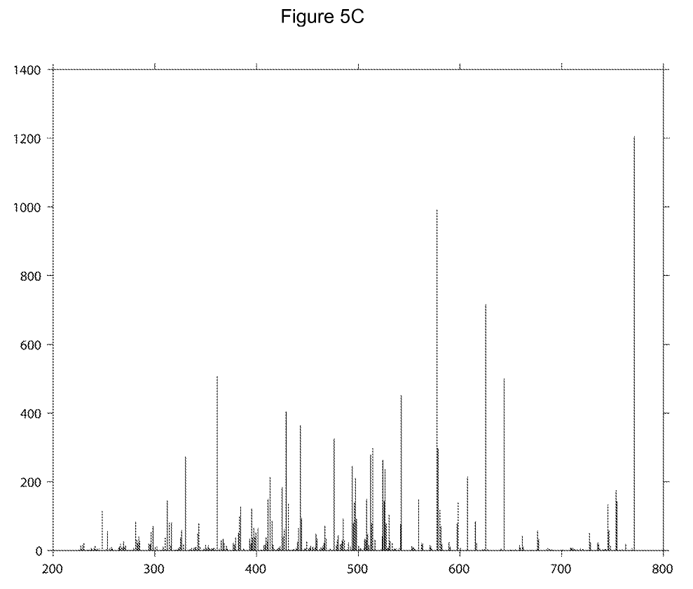

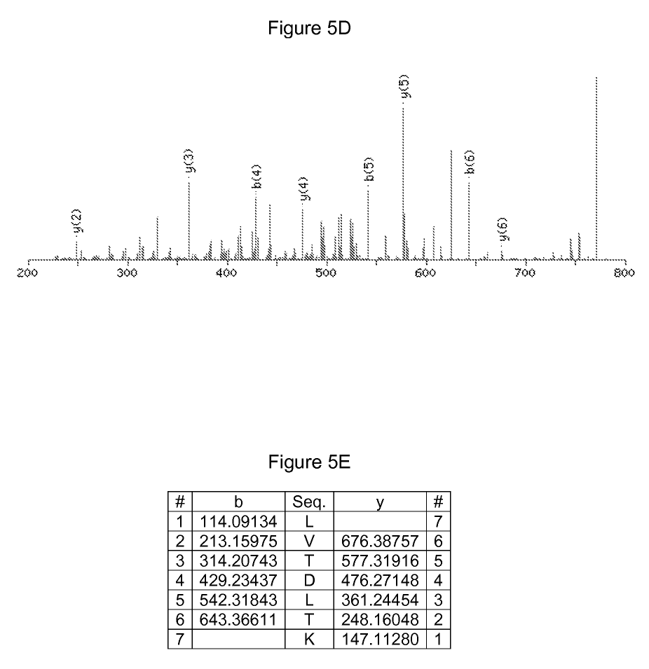

An example is shown in FIGS. 5A to 5E. Out of the 373 peaks in the spectrum, 83 are recognized as background and are removed. As a result, MASCOT was no longer confused and was able to assign a full y-series and many b-ions.

Referring again to Tables 4A and 4B, the MS/MS spectra were interpreted with MASCOT directly (“raw spectra”) or after processing with the background removal procedure (“cleaned spectra”) described in this article. The “score” is the MASCOT score from all successful searches, “match” is the number of searches that recover the peptides from the protein used, and “cov %” reports the sequence coverage. The line “bad spectra” reports the number of files that are considered non-interpretable by the criterion described in the text (n/a=non-applicable). In only one case could MASCOT recognize a peptide from the original protein in a bad spectrum, but with extremely low score.

TABLE 4A
Influence of background removal on the recovery of BSA, ADH,
and TRF in MS/MS spectra of 100 fmol test samples

| search | dta-files | score | match | cov(%) |
|---|---|---|---|---|
| bovine serum albumin | | | | |
| raw spectra | 2679 | 563 | 83 | 54 |
| cleaned spectra | 2484 | 729 | 85 | 55 |
| bad spectra | 195 | n/a | n/a | n/a |
| yeast alcoholdehydrogenase | | | | |
| raw spectra | 2325 | 244 | 35 | 35 |
| cleaned spectra | 2060 | 328 | 33 | 35 |
| bad spectra | 265 | n/a | n/a | n/a |
| human transferrin | | | | |
| raw spectra | 2608 | 582 | 81 | 47 |
| cleaned spectra | 2442 | 748 | 84 | 48 |
| bad spectra | 166 | 64 | 1 | 2 |

TABLE 4B
Changes of scores of leading peptides in MASCOT Searches as a result of
background cleaning

| | BSA | ADH | TRF |
|---|---|---|---|
| Total peptide hits | 70 | 25 | 68 |
| Scores increased | 47 | 18 | 48 |
| Scores unchanged | 5 | 4 | 3 |
| Scores decreased | 13 | 2 | 6 |
| Hits only after cleaning | 5 | 1 | 8 |
| Hits lost after cleaning | 0 | 0 | 3 |

As can be seen from the data in Table 5, the spectral-analytic criteria (removal of latent periodic and high-frequency noise) are most efficient in reducing the background since their share among the removed peaks is above 90%. In the BSA, ADH, and TRF applications, about 15% of all peaks in the original spectra get removed by our program and the file storage requirement is reduced by the same amount.

TABLE 5
Contribution of different procedures in the background removal in the
experiment for recovery of BSA, ADH, and TRF in MS/MS spectra
of 100 fmol test samples

| | (1) | (2) | (3) | (4) | (5) | (6) | (7) |
|---|---|---|---|---|---|---|---|
| BSA | 4293 | 20749 | 1248 | 32570 | 326627 | 50523 | 15.47 |
| | | | | | | (58860) | |
| ADH | 1041 | 12353 | 1402 | 18208 | 215499 | 27940 | 12.97 |
| | | | | | | (33004) | |
| TRF | 3123 | 19297 | 1483 | 28779 | 294546 | 44710 | 15.18 |
| | | | | | | (52682) | |

Four sources contribute to the peak removal: (1) At the start, all peaks with a spacing smaller than the user-defined accuracy are merged (default: 0.25 Da); (2) Number of peaks removed by the periodic noise detection procedure (including de-isotoping); (3) Number of peaks identified by the de-convolution of multiply charged replicates; and (4) Number of peaks found by the routine for high-frequency noise removal. Again, it can be seen that the spectral-analytic criteria are most efficient in background reduction. In the last three columns, there is presented the original spectra (5), the number of peaks removed (6), and the percentage from the total number of peaks (7). Some procedures identify the same peaks as noise. To assess this effect, in column 6, there is presented the arithmetic sum of the numbers from all noise reduction procedures (1-4) in parentheses.

The computational performance of the algorithms of the present invention (denoted IMP MS CLEANER) was tested on a stand-alone PC (under the WINDOWS XP operating system). For the BSA case, 2679 dta-files were cleaned in 4:52 min (0.11 sec per spectrum). The MASCOT time on the same machine reduced from 64 min (for the untreated data) to 57 min (cleaned files). The respective numbers for ADH (2325 files) and TRF (2608 files) are 5:36 (0.14 sec per file), 75, 64 and 4:15 (0.10 sec per file), 58, 50 (all values in minutes). Thus, savings of computational costs are considerable under the condition of increased reliability of spectrum interpretation.

### 7. Application of the Background Removal to the Condensin Dataset.

For exemplifying the algorithm for recognizing non-interpretable spectra according to the present invention, the analysis of condensin complex mass spectra is an even more realistic application compared to the analysis of protein samples because, in the latter example, low concentrations of proteins are intentionally applied to achieve limiting cases of mass spectra.

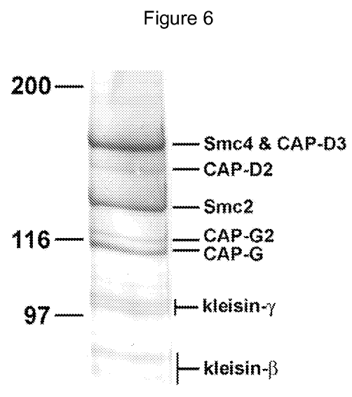

So, for this purpose of analyzing condensing complex mas spectra, the condensing complexes were purified and analyzed from cultured human HeLa cells. Human cells contain two distinct condensin complexes, called condensin I and condensin II, which bind chromosomes specifically in mitosis and contribute to their condensation and structural integrity. Both complexes are hetero-oligomers composed of five subunits. Two ATPase subunits of the structural maintenance of chromosome (SMC) family, called Smc2 and Smc4, are shared between condensin I and condensin II. In addition each complex contains a set of distinct non-SMC subunits, called kleisin-y, CAP-G, and CAP-D2 in the case of condensin I, and kleisin-β, CAP-G2, and CAP-D3 in the case of condensin II. Both complexes were immunopurified simultaneously using antibodies to their common Smc2 subunit and analyzed the resulting sample both by SDS-PAGE and silver staining (FIG. 6) and by in-solution digest followed by LC-MS/MS. Silver staining revealed bands that correspond to Smc2, Smc4 and to all six non-SMC subunits that are present in condensin I and condensin II. The MS/MS spectra were processed using the IMP MS CLEANER., All three datasets, the original, the cleaned, and the bad spectra, were used to perform a MASCOT MS/MS Ions Searches against a small and curated protein database as well as against the non-redundant protein database (all proteins and all human proteins).

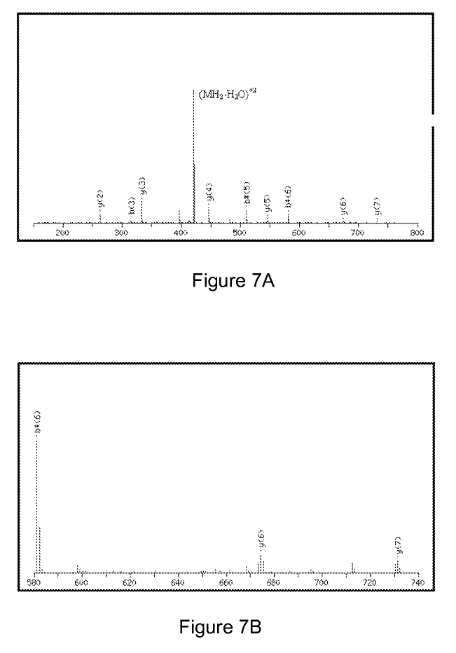

This MS/MS spectrum is from the condensin sample in shown in FIGS. 7A and 7B. FIG. 7A is the full spectrum. This spectrum was classified as ‘bad’ by the IMP MS CLEANER but considered interpretable by Mascot (as QGEVLASAR), although it has very few significant peaks and most of them do not contribute to the peptide interpretation (except for y2, y3, y4, and y5). The major peak in the spectrum represents a doubly charged version of the parental ion after water loss. FIG. 7B is the higher mass-to-charge region in large magnification. MASCOT has assigned y6 and y7 within the background. Indeed, the fine structure of their environments appears as an unusual isotope distribution different from the theoretically expected one.

A summary of the MASCOT search results for the same experiment are shown in Table 6 hereinbelow. Each of the eight condensin subunits showed an increase in MASCOT score (mean increase of 8.2%), and number of peptide matches (mean increase of 4.8%) following the cleaning procedure. As a rule, the percentage sequence coverage obtained was the same or higher for searches using the cleaned spectra than for those using the original spectra. The one exception from this list was kleisin-β, which showed a 2% reduction in the sequence coverage after cleaning. Closer inspection revealed that this reduction was due to one peptide match, which is generated by a single MS/MS spectrum that visually appears of low quality. This MS/MS spectrum has very few significant peaks above the baseline, and is classified as ‘non-interpretable’ by the IMP MS Cleaner. However, MASCOT generated a match between this spectrum and the peptide QGEVLASR (within kleisin-β). With a surprisingly high MASCOT score of 45, it was classified as a hit, although the majority of the significant hits do not contribute to this interpretation. Thus, in this case, the removal of a just single non-reliable peptide during the cleaning process resulted in a small reduction in sequence coverage, although the MASCOT score for the protein as a whole was increased as a result of background removal. It should be noted that all cases of peptide detection by MASCOT in spectra classified as non-interpretable by the algorithm of the present invention (14 out 1318 files) lead to low scores with marginal sequence coverage by MASCOT when there are very few significant peaks above an apparent noise.

The MS/MS spectra were interpreted with MASCOT directly (“raw spectra” from 53944 files with totally 460 MB) or after processing with the background removal procedure (“cleaned spectra” from 52626 files with totally 284 MB) described in this article. The “score” is the MASCOT score from successful searches; “match” is the number of searches that recover the peptides from the protein used. “cov %” reports the sequence coverage. The columns “bad spectra” report cases of files (among 1318 files with totally 7 MB) that are considered non-interpretable by the criterion described in the text (n/a=non-applicable) where MASCOT could, nevertheless, recognize the original protein but with extremely low score and sequence coverage.

TABLE 6
Influence of background removal on the recovery of condensin
components in MS/MS data

| | | raw | | | cleaned | | | incr. | | | bad | |
|---|---|---|---|---|---|---|---|---|---|---|---|---|
| protein | score | match | cov(%) | score | match | cov(%) | score | match | cov(%) | score | match | cov(%) |
| Smc4 | 3768 | 329 | 57 | 4125 | 341 | 64 | 9.5 | 3.6 | 12.3 | 98 | 2 | 1 |
| CAP-D2 | 3637 | 182 | 65 | 4038 | 195 | 69 | 11.0 | 7.1 | 6.2 | 33 | 1 | |
| Smc2 | 2957 | 219 | 55 | 3239 | 231 | 57 | 9.5 | 5.5 | 3.6 | 201 | 4 | 4 |
| CAP-D3 | 2627 | 104 | 42 | 2772 | 108 | 43 | 5.5 | 3.8 | 2.4 | n/a | n/a | n/a |
| CAP-G | 2554 | 106 | 55 | 267 | 110 | 55 | 4.9 | 3.8 | 0.0 | 200 | 3 | 3 |
| CAP-G2 | 1992 | 82 | 44 | 2255 | 86 | 50 | 13.2 | 4.9 | 13.6 | 154 | 3 | 6 |
| Kleisin-γ | 1843 | 78 | 61 | 1979 | 84 | 63 | 7.4 | 7.7 | 3.3 | n/a | n/a | n/a |
| Kleisin-β | 1245 | 45 | 69 | 1306 | 46 | 67 | 4.9 | 2.2 | −2.9 | 45 | 1 | 1 |

In a practical setup, the computational efficiency is also important. IMP MS CLEANER processed the 53944 spectra from the condensin experiment in less than 4 hours on a single standard PC; i.e., in 0.25 seconds per file. The application of background removal procedure reduces the pure Mascot computing time for the body of 53944 dta-files in the condensin complex case by about 25%, even in the case of a small database of 146 sequences; the size of the cleaned mgf-file is decreased by 39%. Therefore, application of the IMP MS Cleaner significantly reduces consumption of computing time and storage.

The background from multiply charged replicates, isotope variants, sample-specific and systematic contaminations, and the noise from the electronic detection system create a considerable problem during mass spectrum interpretation. Computation time is wasted for non-interpretable spectra and background peaks occupy a significant share of the storage capacity for mass-spectrometric data. Background removal according to the present invention improves reliability of hit assignments by database search-based methods considerably.

What is claimed is:

1. A method for processing raw protein tandem MS/MS spectral data which comprises:
(a) detecting multiply-charged peaks or replicates;
(b) transforming the multiply-charged replicates into singly-charged mono-isotopic peaks;
(c) removing latent periodic noise including de-isotoping;
(d) removing high-frequency noise; and
(e) detecting non-interpretable spectra.

2. A method for checking for sequence ladder tags in an MS/MS spectrum that originates from a peptide as distinguished from a non-peptide spectrum before interpreting the MS/MS spectrum, the method comprising the steps of identifying the presence of an amino acid sequence ladder of peaks, wherein distances between the peaks are characteristic of the amino acid residue mass, and, if the MS/MS spectrum does not contain a reliable number of peaks that form the amino acid sequence ladder, the MS/MS spectrum is removed from the set of spectra that is to be used for interpretation.
